(19) United States
(12) Patent Application Publication
(10) Pub. No.: US 2009/0095160 A1
(43) Pub. Date: Apr. 16, 2009

(54) ELECTROSTATICALLY CHARGED ENGINE INTAKE FILTER MEDIA

(76) Inventors: Ronald TROXELL, Lake Forest, IL (US); Jason TROXELL, Lake Forest, IL (US); Roy E. GREENLEES, Lake Forest, IL (US)

Correspondence Address: ORUM & ROTH LLC, 53 W. JACKSON BLVD., SUITE 1616, CHICAGO, IL, 60604, US

(21) Appl. No.: 12/251,226

(22) Filed: Oct. 14, 2008

Related U.S. Application Data
(60) Provisional application No. 60/998,861, filed on Oct. 12, 2007.

(51) Int. Cl. B01D 53/92; F01N 3/021; F01N 3/01

(52) U.S. Cl. 96/15; 55/385.3

(57) ABSTRACT

A filter for internal combustion engine air intake comprised of a synthetic fiber media uniquely enhanced with an electrostatic charge. The media described in this application is a low restriction synthetic fiber media enhanced with an electrostatic charge applied to the media fibers to greatly improve efficiency and dust holding capacity. This charge is so effective that unlike other mechanical filters the initial efficiency of this media is as high, or higher than its efficiency after use. The applied charge will either attract particles of an opposite charge that might otherwise pass through the media or in cases of particles with similar charges an induced dipole is formed to attract those particles. The claims of this patent will not be for the method of enhancing this media but for its use and configuration for use in engine intake air filtration.

### BACKGROUND OF THE INVENTION

1. Field of the Invention

A filter for internal combustion engine air intake comprised of a synthetic fiber media uniquely enhanced with an electrostatic charge.

The ideal filter media would be one that has a very high initial efficiency, very low restriction to flow and a high dust holding capacity for long service life.

2. Summary of the Prior Art

Common engine air filters are typically constructed of cellulose fiber or synthetic fiber based media, with cellulose media typically having higher restriction to flow and lower dust holding capacity but having higher cleaning efficiency. Synthetic fiber media is often constructed to have lower restriction to flow but can hold more contaminant before becoming restrictive but at a lower cleaning efficiency.

Either of these media can be configured to improve any one of their performance characteristics but always at the expense of some other performance area. Spreading the fibers can reduce restriction but it also reduces efficiency. Using finer fibers closer together can increase efficiency without excessive increases in restriction but the dust holding capacity decreases dramatically.

All standard, non-enhanced media efficiencies begin at their lowest levels when they are new and clean (commonly referred to as initial efficiency) and then will gain efficiency as they accumulate dust. These collected dust particles actually form a barrier on the surface of the filter fibers but until those particles form on the filter the media performs poorly.

### SUMMARY OF THE INVENTION

The media described in this application is a low restriction synthetic fiber media enhanced with an electrostatic charge applied to the media fibers to greatly improve efficiency and dust holding capacity. This charge is so effective that unlike other mechanical filters the initial efficiency of this media is as high, or higher than its efficiency after use.

The applied charge will either attract particles of an opposite charge that might otherwise pass through the media or in cases of particles with similar charges an induced dipole is formed to attract those particles.

This invention is for its use and configuration for use in engine intake air filtration.

### DETAILED DESCRIPTION OF THE INVENTION

The present invention is a new innovative concept which provides the most effective solution in filtering particulates down to 0.05 microns in size.

Typical mechanical filter media used to remove particles at this smallest size fraction require the use of extremely fine fibres. These materials, whilst often achieving high efficiencies, are usually associated with the inherent disadvantages of low dust holding capacity and high resistance to air flow.

The present invention consists of a unique blend of synthetic fibers which, during the manufacturing process, generate electrical charges on the fiber surface. The result is a highly stable, coarse fibered electrostatic filter media.

It is a combination of the present invention's electrostatic properties and coarse fibers which give the benefit of a high dust loading capacity, low air flow resistance and high efficiencies against sub-micron particles.

The present invention offers flexibility to fabricators whilst meeting their specific filtration requirements. It is this flexibility that allows lamination to a variety of different substrates. This imparts additional properties such as palatability, odor removal and mouldability.

The present invention can be supplied in rolled, sheet, cut pad or pleated forms. The media is a needled felt, coarse fiber fully synthetic blend of polyester and acrylic fibers (2). Triboelectric charge is created during needling process of media manufacture. Charge is stable for a minimum of three years and unaffected by ambient conditions. It can be any thickness, however current technology9 requires thickness of approximately 0.060″-0.100″ to be suitable for engine intake air filtration. The current product in development uses approximately 0.080″ thick material

The media is co-pleated with aluminum or other type of wire mesh (1) support on one or both sides in a variety of pleat heights. The wire mesh may also be non-pleated and may cover the outside and or inside of the filter media. Wire mesh is used to support media, however other methods may be employed such as a pleatable plastic mesh laminate backing. The filter configuration may be cylindrical, oval, frustro-conical, or flat panels in any aspect ratio. Media may be potted into molded endcaps (3) that also comprises of the filter seal, utilizing a resin material such as polyurethane or a plastisol. Or it may be potted with a similar resin material into an end cap composed of any type of metal or composite using a separate gasket material to create a positive seal. The filter is designed to be cleanable with a compressed air nozzle utilizing shop air blown from the downstream side of the media out toward the upstream side and then reused with minimal loss of performance.

The invention integrates this type of filter media into engine air filters, particularly automotive air filtration.

### BRIEF DESCRIPTION OF THE FIGURES

FIG. 1. Penetration

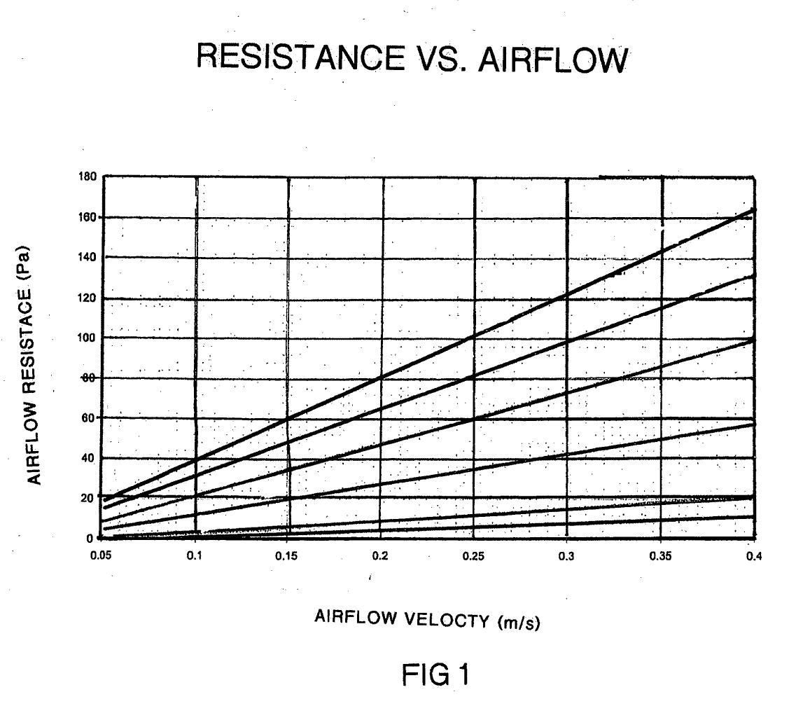

The present invention basis weights from 90 to 500 g/m² are plotted against percentage penetration of a nominal 0.65 micron poly-disperse NaCl aerosol challenge (BS4400) is shown below.

FIG. 2. Airflow resistance

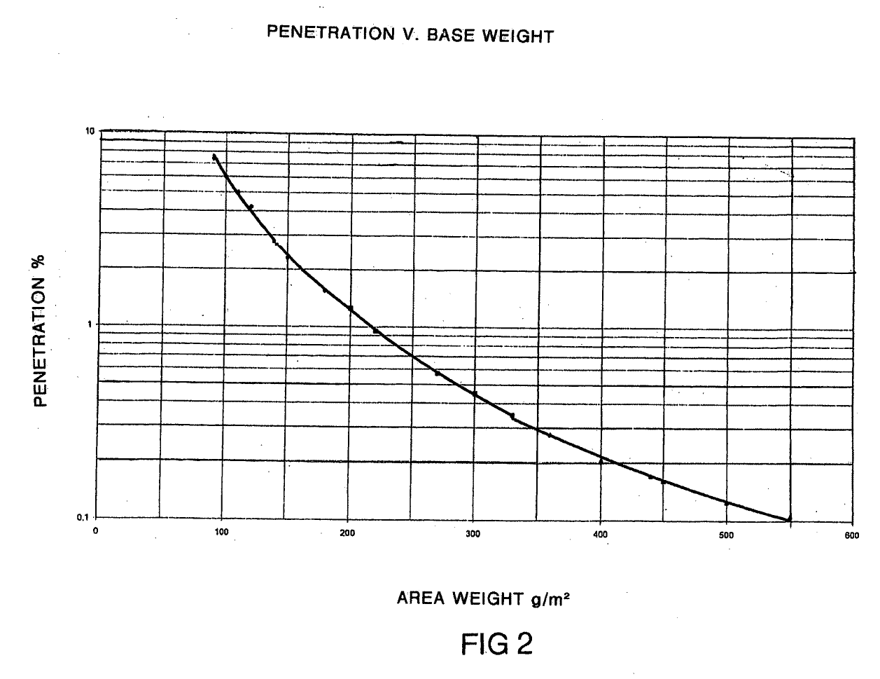

Airflow resistance for the present invention weights from 50 to 500 g/m² against media velocities from 0.05 to 0.3 m/sec are plotted below. Click on the diagram for a larger version.

FIG. 3. The Present Invention Typical Specifications

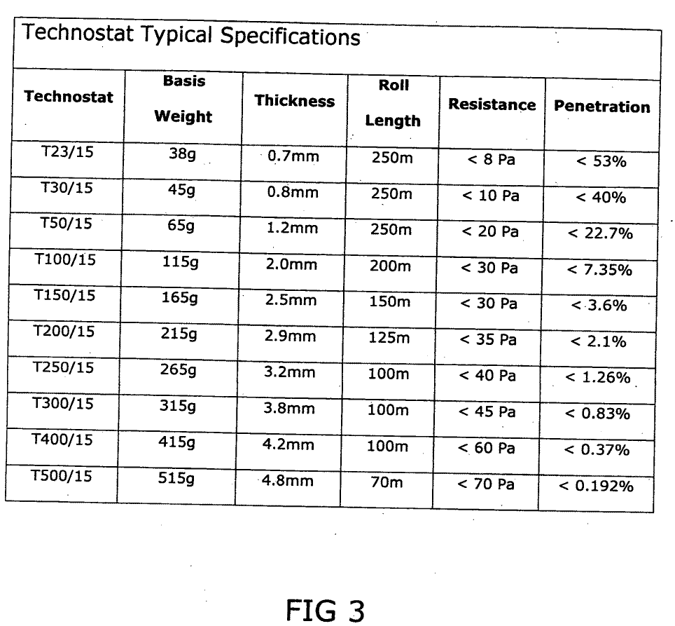

FIG. 4. Top View of Filter.

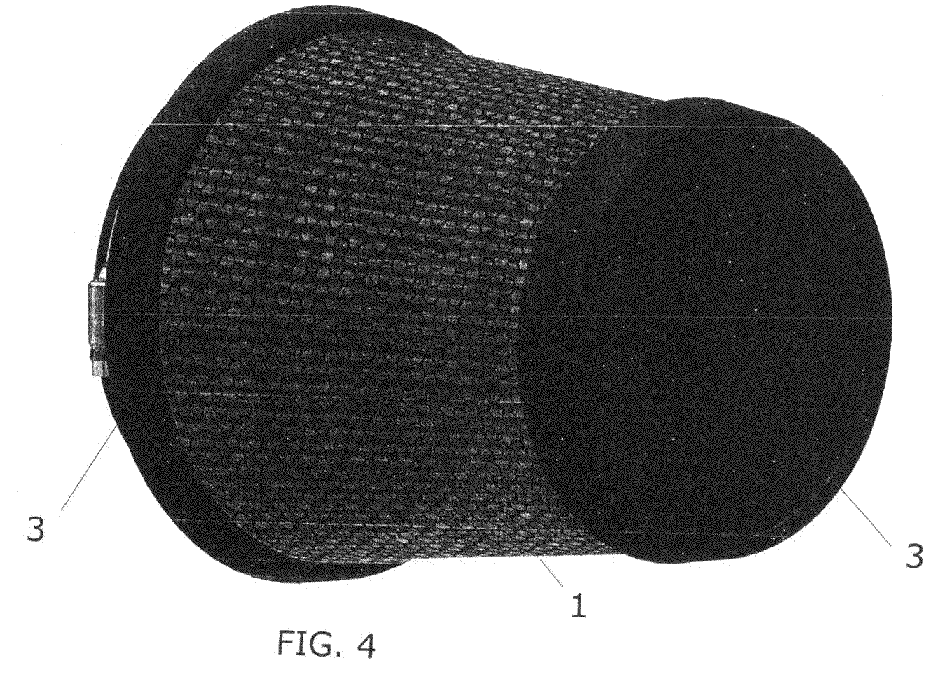

FIG. 5. Outlet View of Filter.

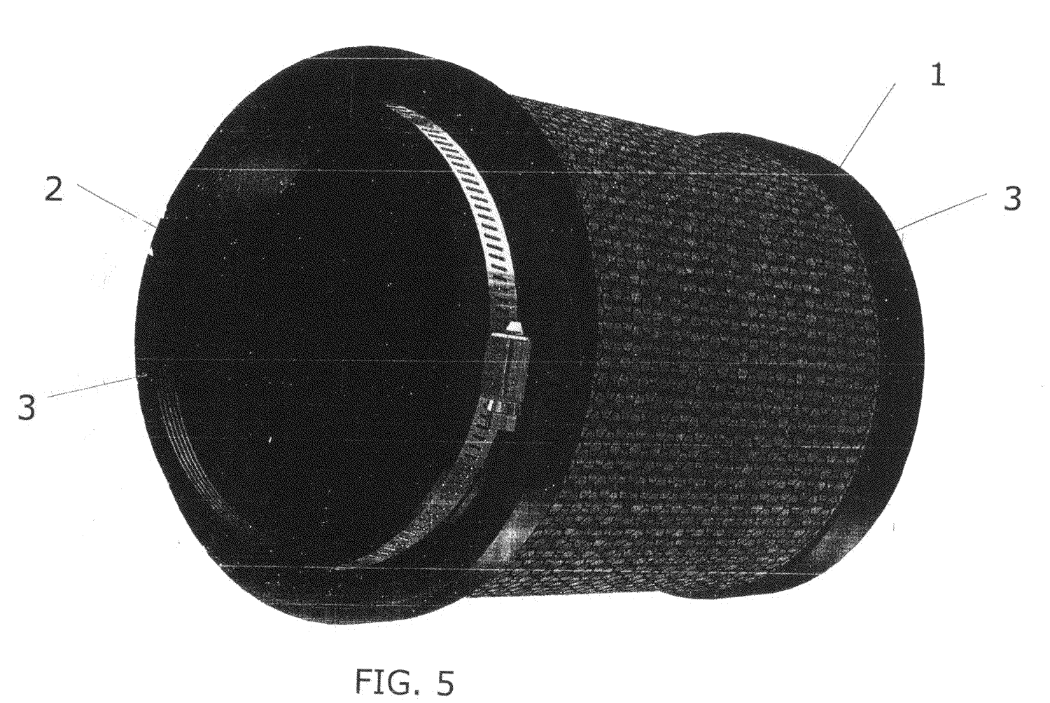

FIG. 6. Side View of Filter.

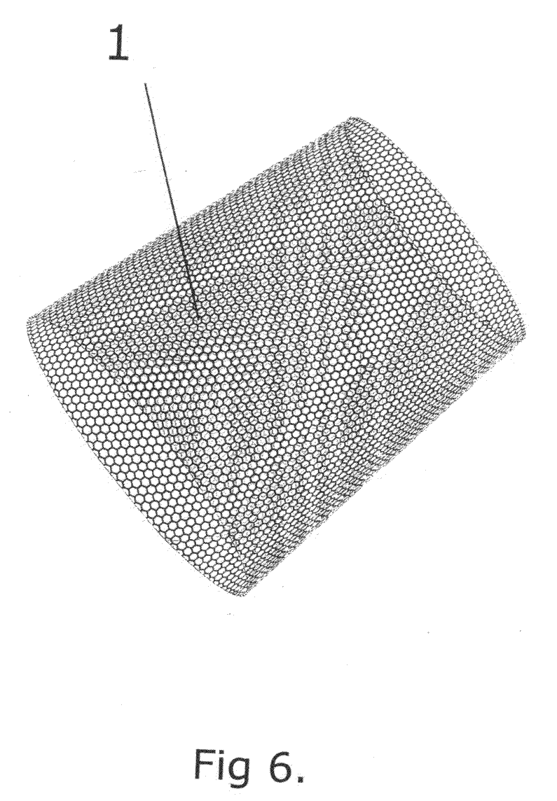

1. A low-restriction, high capacity air filter for an internal combustion engine, comprising: a filter media, the filter media being a coarse fiber fully synthetic material.

2. A low restriction, high capacity air filter for an internal combustion engine, according to claim 1, wherein the material is a blend of polyester and acrylic fibers.

3. A low restriction, high capacity air filter for an internal combustion engine, according to claim 2, wherein the media is a needled felt.

4. A low restriction, high capacity air filter for an internal combustion engine, according to claim 3, further comprising a triboelectric charge imposed on the filter material fibers, the charge being present for a minimum of three years.

5. A low restriction, high capacity air filter for an internal combustion engine, according to claim 4, wherein the media is in the thickness range of 0.060-0.100 inches.

6. A low restriction, high capacity air filter for an internal combustion engine, according to claim 5, wherein the media is co-pleated on both sides with a wire mesh.

7. A low restriction, high capacity air filter for an internal combustion engine, according to claim 6, wherein the wire mesh has openings in the shape of regular hexagons.

8. A low restriction, high capacity air filter for an internal combustion engine, according to claim 7, wherein the filter media is cylinder shaped.

9. A low restriction, high capacity air filter for an internal combustion engine, according to claim 7, wherein the filter media is frustro-conically shaped.

10. A low restriction, high capacity air filter for an internal combustion engine, according to claim 7, wherein the filter media is in a flat-panel shape.

11. A low restriction, high capacity air filter for an internal combustion engine, according to claim 7, further comprising end-caps being of a resin material.
